(19) United States
(12) Patent Application Publication
(10) Pub. No.: US 2003/0092955 A1
(43) Pub. Date: May 15, 2003

(54) Method for the elimination of hazardous waste from dry cleaning waste products

(76) Inventors: Kenneth W. Mouw, Yreka, CA (US); Aaron J. Cena, Mt. Shasta, CA (US); Mark E. Moore, Versailles, KY (US); Mark J. Stuerenberg, Ft. Wright, KY (US)

Correspondence Address: Douglas F. Kimball, 612 Webster Ave, Wheaton, IL, 60187, US

(21) Appl. No.: 10/045,388

(22) Filed: Nov. 9, 2001

(51) Int. Cl. A62D 3/00

(52) U.S. Cl. 588/206

(57) ABSTRACT

A process is disclosed for the elimination of perchloroethylene from the waste products of the dry cleaning solvent recycling process. The process consists of placing the solutions and objects contaminated with the perchloroethylene in a containment chamber, and adding ozone to the chamber until the perchloroethylene is eliminated from the waste products. The addition of catalysts or ultraviolet light to the process can increase the speed of elimination of the perchloroethylene. Another feature would re-circulate ozone that has escaped from the solution to improve the efficiency and reduce energy input into the process.

### BACKGROUND OF THE INVENTION

The present invention relates to the field of hazardous waste elimination, and more specifically, to the elimination of perchloroethylene from dry-cleaning waste products.

Dry cleaning is the process of using a solvent other than water to clean fabric. Many organic solvents could be used, but the most common solvent in use today is perchloroethylene (hereinafter PERC), also known as tetrachloroethylene or ethylene tetrachloride. Other applications of PERC are industrial degreasers and spot removers. As the PERC is used in the dry cleaning process, impurities and contaminates will build up in the solution. Periodically, it is necessary to remove these impurities and contaminates from the working dry cleaning fluid to have good efficiency in the dry cleaning process. The purification process will typically consist first of a filtration step to remove the solid material and next a distillation step to purify the PERC and leave the aqueous and oily residue behind. Both of the purification steps generate waste material, filters or the aqueous residue, that are highly contaminated with the PERC. These waste products require special handling and disposal because the PERC is damaging to the environment.

### SUMMARY OF THE INVENTION

The present invention provides a method for treating the waste products, such as filters and distillation waste, from the PERC purification process to eliminate the PERC from the waste products. Once the PERC is eliminated from the waste products, the waste products could be safely returned to the environment without special handling and extra cost. The method would do this by treating the waste products with ozone or the combination of ozone and a catalyst. The catalyst would speed up the action of the ozone and, therefore, decrease the time the process would take. Ozone is a highly reactive chemical that is known to break down many organic compounds.

An object of the invention is to allow the waste products and filters from the PERC purification process to be returned to the environment as non-hazardous waste.

Another object of the invention is to eliminate the PERC from the waste products of PERC purification without releasing any PERC into the atmosphere.

A further object of the invention is to eliminate the PERC from the waste products in a single treatment step.

### BRIEF DESCRIPTION OF THE DRAWINGS

FIG. 1 is a flow diagram of the process with ozone being used to eliminate the PERC.

FIG. 2 is a flow diagram of the process that includes the re-circulation of the ozone that is applied to the solution.

FIG. 3 is a flow diagram of the process in which a catalyst has been added to the solution.

FIG. 4 is a flow diagram of the process in which ultraviolet radiation is applied to the solution.

### DETAILED DESCRIPTION OF THE INVENTION

When PERC is reprocessed and repurified after it has been used in the dry cleaning process, the waste product is a liquid. The liquid is the residual product after the distillation of the PERC and contains water, dirt, residual oils extracted by the dry cleaning and residual PERC. The residual PERC makes the waste product an environmental hazard.

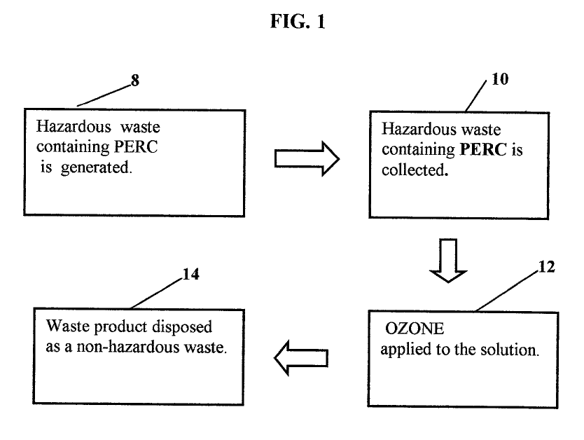

FIG. 1 is a schematic diagram of the process. The hazardous waste is generated 8 from reprocessing and purification of the PERC. The residual liquid is collected 10 and is stored in a container. The exact nature of the container is not critical to the invention. The nature of the container may depend on the size of the reprocessing operation more than a need for a particular type of container. A large reprocessing site may use a large stainless steel container whereas a small site may use a smaller glass or ceramic container.

The filters which are often used in the reprocessing of the PERC and are thus also contaminated waste, would be placed in the liquid for the decontamination process. The filter would contain PERC entrapped in the filter membrane and that entrapped PERC would exchange slowly with bulk of the solution. Thus the ozone would eventually decompose PERC in the filter although it may take a longer time than if the treatment was for a solely liquid system. Any other solid or semi-solid material would also be placed in the liquid. Usually the residual matter from the distillation process is a liquid but if it is a solid, the material to be treated could be warmed to transform it into a liquid. This might be the case if the dry cleaning process was used to clean high molecular weight fats and oils from garments. The process works at temperatures from about 40 degrees Fahrenheit to about 180 degrees Fahrenheit with no difference in outcome. It would be preferable to work at ambient temperature because the cost of energy input to the process would be less.

Once the treatment container contains an appropriate amount of material, ozone 12 is applied to the solution. The solution as it is referred to hereinafter may be a mixture of liquid and/or solid objects. The application of ozone to a liquid is well known in the prior art. Chemically, the ozone, which is a compound of three oxygen atoms, decomposes rapidly into an oxygen molecule and an oxygen free radical. Because ozone decomposes so rapidly, it must be generated close to the application site. The oxygen free radical is extremely reactive and reacts with many molecules including PERC to decompose them to carbon dioxide, water and simple chloride compounds. There are two basic ways to introduce gaseous ozone into a liquid. The first is to bubble the gas through the liquid under a slight positive pressure. The smaller the bubbles produced the more efficient the transfer process from the gas phase to the liquid phase. This is referred to as micro-bubbles in the ozone treatment technology. The second way to introduce the gaseous ozone is at ambient or below ambient pressure by pumping the liquid through a venturi apparatus. The venturi pulls the gas in as the liquid passes through a tube at relatively high velocity. A small opening in the path of the high velocity liquid is connected by a tube to the ozone generation device. As the liquid passes the small opening, it pulls into the liquid stream the gaseous ozone. Finally, it would be possible to create a liquid solution of ozone by introducing ozone into a separate liquid in a separate container by either the micro-bubble or venturi methods, and then adding that solution of liquid and ozone to the treatment container. This separate liquid could be either an aqueous or a non-aqueous liquid. Although the addition of a separate liquid would involve an extra step in the process, it may be advantageous to expose the ozone dispersal system to a liquid that is not extremely contaminated to decrease the maintenance time and costs it requires. Adding an additional amount of liquid to the contaminated solution and contaminated filters may aid in the dispersal of the ozone into the contaminated solution.

Ozone is generated by high voltage electric discharge apparatus well known in the prior art close to the site of application, in this case the treatment container (see U.S. Pat. No. 5,573,730 issued to T. J. Gillum in 1996). The electric discharge generates ozone from atmospheric oxygen.

When the treatment of the solution is complete, the waste product 14 will be disposed of as non-hazardous waste.

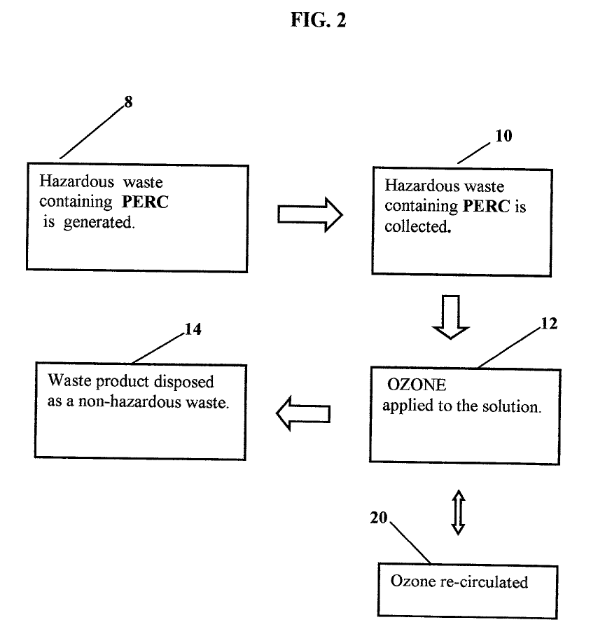

A further refinement on the process would be to re-circulate the gaseous ozone that escapes from the treatment container back into the liquid. In FIG. 2 the process is modified with a re-circulation system 20 attached to treatment container. Ozone is highly soluble in most liquids, but re-circulating the gas escaping from the liquid would improve the overall efficiency by keeping a higher concentration of ozone in the liquid without the cost of generating more ozone.

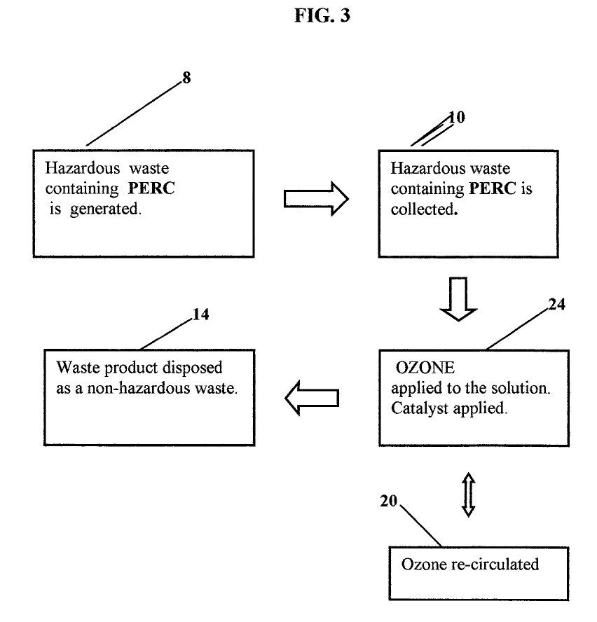

The application of ozone to the liquid contaminated with PERC may take from 2 hours to 4 days to reduce the concentration of PERC to below detectable limits. A way to increase the speed of the process would be to add a catalyst to the reaction mixture. Catalysts that are known in the prior art to increase the rate of the ozone decomposition reaction (and consequently the ozone elimination of chemicals) are iron ions, manganese ions, hydrogen peroxide, ultraviolet radiation, or a pH greater than 7.0. Either of the metal ions could be added to contaminated liquid as a soluble salt of the metal. The hydrogen peroxide can be added as a liquid solution of hydrogen peroxide that is available in different concentrations. The pH of the solution could be adjusted to greater than 7.0 by the addition of a chemical base, such as sodium hydroxide to the contaminated liquid. FIG. 3 shows the process with a catalyst added to the contaminated liquid 24 as the ozone is applied.

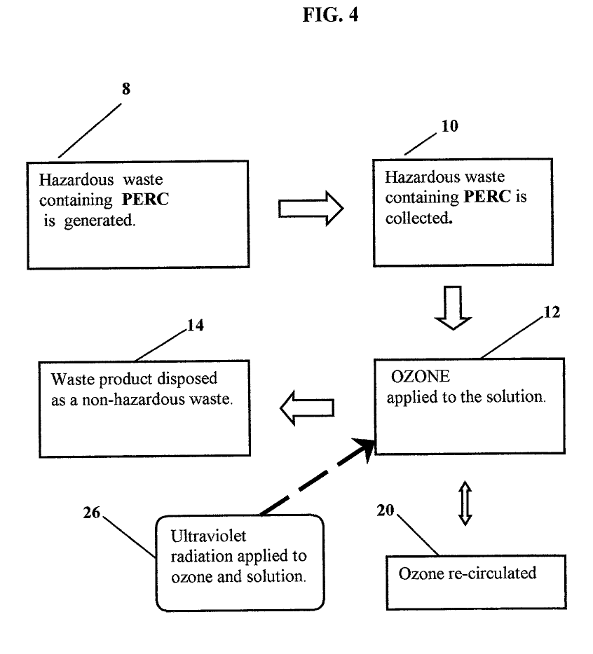

FIG. 4 shows the process with UV (ultraviolet) radiation 26 radiating the solution. A UV sterilizer lamp properly positioned in the treatment train would give results comparable to the aforementioned catalysts. UV radiation breaks the ozone molecule into an oxygen molecule and an oxygen free radical. It is the oxygen free radical that reacts with the organic compound. Thus an increase in free radical concentration will increase the speed of PERC elimination. It may also be advantageous to agitate the contaminated liquid or vigorously pump the solution in the venturi ozone infusion method to increase the dispersion of ozone within the liquid although diffusion of the ozone without agitation in the liquid is usually adequate.

We claim:

1. A process for eliminating perchloroethylene from a perchloroethylene contaminated solution comprising:
placing a contaminated solution containing perchloroethylene in a container;
adding a sufficient amount of ozone to the contaminated solution whereby the ozone will react with and eliminate the perchloroethylene.

2. A process as claimed in claim 1 wherein solid objects contaminated with perchloroethylene are placed in the contaminated solution prior to the addition of the ozone whereby the perchloroethylene is eliminated from the solid objects.

3. A process as claimed in claim 1 wherein ozone is infused into the contaminated solution by means of micro-bubbles.

4. A process as claimed in claim 1 wherein ozone is infused into a flowing steam of the contaminated solution by a venturi means.

5. A process as claimed in claim 1 wherein gaseous products escaping from the contaminated solution are re-circulated into the container.

6. A process as claimed in claim 1 wherein a catalyst that increases the rate of ozone decomposition is added to the contaminated solution.

7. A process as claimed in claim 6 wherein the catalyst is a substance selected from the group of iron, manganese, and hydrogen peroxide.

8. A process as claimed in claim 6 wherein the catalyst is a substance that increases the pH of the contaminated solution to a value greater than 7.0.

9. A process as claimed in claim 6 wherein ultraviolet radiation is used to increase the rate of ozone decomposition.

10. A process as claimed in claim 1 wherein a liquid containing ozone is added to the contaminated solution.
